(19) United States
(12) Patent Application Publication
(10) Pub. No.: US 2002/0107775 A1
(43) Pub. Date: Aug. 8, 2002

(54) Automated bidding process and system

(76) Inventor: B. J. Hawkins, Marina Del Rey, CA (US)

Correspondence Address: LEVIN & HAWES, P O BOX 4140, LAGUNA BEACH, CA, 92652

(21) Appl. No.: 09/776,248

(22) Filed: Feb. 2, 2001

(51) Int. Cl. G06F 17/60

(52) U.S. Cl. 705/37

(57) ABSTRACT

An integrated, efficient, timely and easy to use system and method is disclosed for product and service procurement from outside vendors by an organization. The system incorporates best business practices. The system provides for posting of a requisition requesting bids at a publicly accessible site, such as a server attached to the Internet. Allowing registered product and service providers the option of entering bids, revising bids and withdrawing bids during a preset bidding period. Upon the closing of the bidding period, reviewing the bids and awarding the contract for the requisition based on a preset criteria to one or more the bidding product or service providers. The system allows for the awarding of a requisition to one or more than one product or service provider. The system can be integrated into an internal product and service requisition authorization system used by the organization.

A portion of the disclosure of this patent document contains material that is subject to copyright protection. The copyright owner has no objection to facsimile reproduction by any one of the patent disclosure, as it appears in the Patent and Trademark Office patent files or records, but otherwise reserves all copyright rights whatsoever.

### FIELD OF THE INVENTION

The present invention relates to a method and system for administrative action and decision-making and more particularly a system and process for managing and organizing procurement of products and services for an organization.

### BACKGROUND OF THE INVENTION

Organizations no matter what the size require systems and rules to govern their operation. Some of these systems are internally generated, others are standard business practices developed from pre-established norms based on recognized fundamentals of a properly run business. Procurement systems whereby an organization obtains products or services are one of many such type of systems common to any organization of at least moderate size. In such a system one has to balance the need for the organization to obtain necessary products and services in a timely fashion against a need to prevent fraud and waste.

Over the years best business practices have developed that most organizations use in one form or another in the procurement process. These systems are composed of a series of checks and balances and often call for the obtaining of bids from two or more reputable suppliers before making a final decision on purchasing a product or service. Best business practices also include identifying and informing the largest possible number of potential qualified suppliers of services and products of the existence of a pending requisition to assure a sufficient number of bids from which to make a final purchasing decision. These best business practices go beyond the mere maximizing the number of qualified suppliers interested in bidding and include the internal organization of the purchasing department to assure timely, efficient and waste procurement. Thus, they include establishing the proper structure within the purchasing department to assure a workflow that assigns the work to be done in a fair and effective manner, provides for effective oversight within the organization, and does so in a timely and efficient manner.

Additionally, there is a need to develop an integrated system of best business practices for procurement of products and services that is adaptable to many different situations including but not limited to one that can be used on a networked computer system in particular one a combined intranet system (a local area network), and internet system.

However, up until the present there has been a failure to identity and integrate in a systematic way all of these best business practices into a system that optimizes all of the advantages of these best business practices. In some respects a number of these practices have the potential effect of creating contrary results do to the different priorities each of these best business practices are designed to achieve. Thus, practices designed to prevent fraud and waste have a tendency to work against those practices that are designed to assure speed and efficiency.

Consequently, what is needed is a system and process that integrates in an effective efficient, timely yet fraud and waste free manner these best business practices. Such a system must also be flexible enough to be adapted for use by a wide variety of organizations that includes not only private business organizations but also municipalities as well as other public and quasi-public organizations.

### SUMMARY

It is an objective of the present invention to provide in an integrated, effective, efficient, fraud free, waste free and timely manner a product and service procurement system and process. It is an additional objective to provide a product and procurement system and process that can be used by a wide variety of organizations ranging from for profit business to public and quasi-public organizations. It is a further objective of the present invention to provide a system that is adaptable to a wide variety of implementations including but not limited to a networked computer system attached to the internet.

The present invention accomplishes these and other objectives by providing a method for an organization to conduct a procurement process for products or services it needs by the steps of: a) creating a requisition for purchase of sundry items or services needed; b) posting the requisition for purchase wherein the requisition is accessible by suppliers of services and products who may be interested in bidding to supply the product or service sought by the requisition; c) notifying a list of approved prospective suppliers of the services or products requested in the requisition, of the existence of the pending requisition; d) accepting from prospective suppliers, that are registered and approved suppliers, bids for supplying the product or service sought by the requisition; e) allowing the product or service suppliers bidding to amend or withdraw their bid prior to the closing of the bidding process, f) closing the bidding process at a preset date; g) and awarding the requisition to one of the prospective suppliers that submitted a bid.

In a further aspect of the present invention it provides a procurement process for obtaining products or services it needs on a computer system over the internet by the steps of: a) creating a requisition for purchase of sundry items or services needed; b) posting the requisition for purchase on a computer attached to the internet wherein the requisition is accessible by third parties over the internet; c) notifying by electronic mail prospective suppliers of the services or products requested in the requisition, of the existence of the pending requisition; d) allowing prospective suppliers to access view the requisition on line; e) accepting from prospective suppliers electronic bids for supplying the product or service sought by the requisition; f) closing the bidding process at a preset date; and g) awarding the requisition to one of the prospective suppliers that submitted a bid.

In a further aspect of the method of the present invention it provides a method of: a) requiring any potential supplier that wants to bid to register; b) registering by the potential seller includes providing contact information and other information deemed relevant by the organization; c) verifying by the organization said potential supplier meets certain predefined criteria; and d) approving said potential supplier as an authorized supplier with authority to submit bids when said potential suppliers meets said predefined criteria.

In a different aspect of the present invention it provides a system for soliciting bids from potential suppliers for product or service needs of an organization over the internet that includes: a) a computer of an organization connected to the internet; b) an interactive memory site on said computer accessible from the internet by third parties connected to the internet; c) requisitions for purchases sought by the organization stored at said interactive site and for viewing by those who obtain access to the site from the internet; and d) bid protocol available to third party suppliers to view requisitions at said interactive memory site and leave an offer to supply a product or service itemized in the requisition, when said third party supplier obtains access to said interactive memory location from a connection to the internet.

In a further aspect of the system of the present invention the bid protocol also provides for the classification of individuals within the organization using the system as buyers who prepare the requisitions for the bid process, business administrators with authority to appoint buyers and authorize suppliers to register so they can bid on requisitions, systems managers to manage technical aspects of the entire system and purchasing directors who have access to all requisitions and authority to appoint buyers and authorize suppliers to register so they can bid on requisitions.

### BRIEF DESCRIPTION OF THE DRAWINGS

The invention will be better understood by an examination of the following description, together with the accompanying drawings, in which:

FIG. 1 is a flow chart that provides an overall view of the basic steps of the process of the present invention;

FIG. 2 is a flow chart of the internal organizational structure that manages the fulfilling of the requisitions upon reaching purchasing;

FIG. 2A is a block diagram the functional structure used in the purchasing department to control the workflow of the requisitions for purchase;

FIG. 3 is a flow chart of a preferred embodiment of a registration process a prospective supplier may use to qualify for the right to submit bids;

FIG. 4 is a flow chart of a subroutine of a preferred embodiment of the present invention for preparation and posting of a requisition for purchase;

FIGS. 4A to 4F depict computer screens of the present invention a Buyer might use in preparing a requisition for purchase;

FIG. 5 is flow chart depicting the steps a supplier would use to submit a bid in a preferred embodiment of the present invention;

FIGS. 5A to 5M depict computer screens a potential supplier might encounter when reviewing and making a bid to supply products or services on requisitions for purchase at the website of an organization using the present invention;

FIG. 6 is a flow chart depicting the steps a buyer would use in selecting a supplier to award the requisition to;

FIGS. 6A to 6D depicts computer screens a Buyer might use to review bids and award a requisition for purchase to a single supplier;

FIGS. 6E to 6J depict computer screens a Buyer might use to review and award a requisition for purchase to two or more suppliers when the requisition is designated on that can be awarded to two or more suppliers; and

FIG. 7 is a block diagram of the major functional parts of a preferred embodiment of the present invention and the environment in which they function.

### DETAILED DESCRIPTION OF THE PREFERRED EMBODIMENT

I. The System and Method

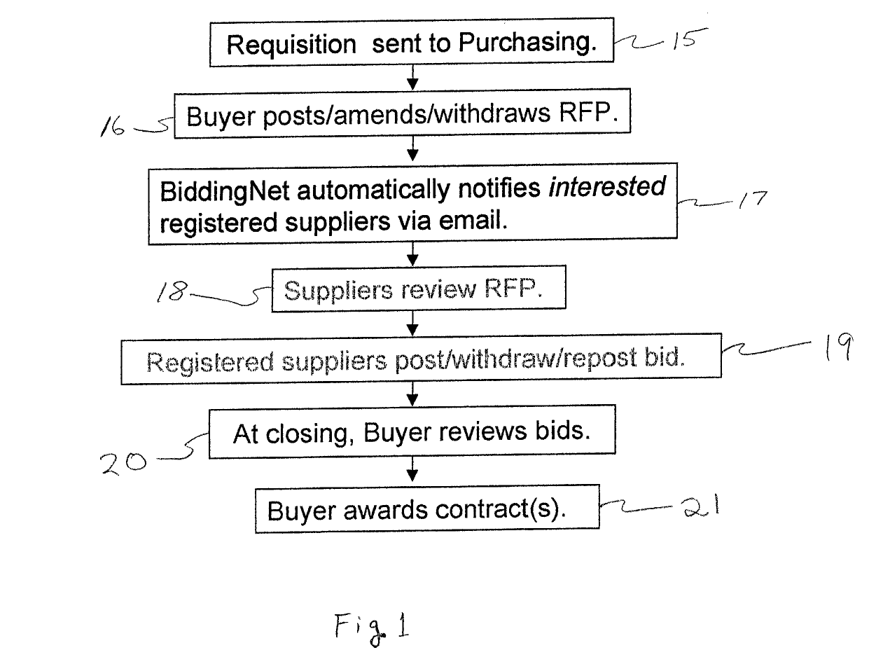

The present invention utilizes, in an integrated and unique fashion, the best business practices, as they relate to the process of bidding, to create a process and system for soliciting bids for services and products from a variety of suppliers. FIG. 1 provides an overview of the system and how it works. A requisition (a request for the purchase of goods or services) arrives at the purchasing department 15 and a Buyer, a person assigned to handle purchase of products and services, reviews it, prepares it for solicitation of bids and, in a preferred embodiment of the invention, posts it 16 on the organizations computer system for public view at that organization's website as a requisition of goods (RFP). The Buyer, as will be explained in more detail below, can amend or withdraw the RFP if and when necessary during the bidding period. The system, upon the posting of the RFP immediately notifies interested registered vendors or suppliers 17, the vendors having previously registered with the system (the terms vendor and supplier may be used interchangeably in this specification). The suppliers when they registered provided among other things their specific areas of interest for which they can provide supplies or services. The areas of interest being defined as the types of services or products for which the supplier would be interested in submitting bids.

Once the prospective supplier receives notice of the pending requisition for purchase the supplier would go to the website of the organization to view the particulars of the RFP 18. The system would also allow a prospective supplier during the bidding period to ask questions about the pending requisition and those questions from suppliers and their answers could be made public for the reference of other prospective suppliers interested in bidding on the RFP or be kept private and not disclosed. The supplier, assuming the supplier is a registered supplier, has the option of bidding on the RFP 19. The supplier after bidding also has the option of withdrawing and reposting a bid 19 during the bidding period. When the bidding period closes the Buyer reviews the bids 20 and awards the contract for the requisition to one of the bidding suppliers 21. Naturally, the award of the contract would be based on criteria adopted by the organization. The Buyer also has the option of splitting the RFP between several bidding suppliers.

The present invention can be implemented in a variety of ways with or without the aid of a computer system. However, the preferred embodiment of the invention described herein presents the invention implemented in a network computer system attached to the internet. Most organizations, governmental, business, educational etc., be they large or small, have or are in the process of restructuring their operations around personal computers operating on a network. Employees in these organizations, from clerical to executive, generally each have their own computer workstations consisting of a personal computer connected to the network. Additionally, these systems include a server with accessible data files and shared software programs. The systems in turn are generally connected to the internet to allow the employee to access various resources available over the internet. Additionally, each employee has there own unique electronic address, generally an e-mail address, that is part of an electronic mail system that allows the employee to communicate electronically with those within the organization. The employee can also communicate by e-mail with persons outside of the organization who are connected to the internet and have an e-mail address. Thus, increasingly, business transactions are being conducted over the internet.

As noted above the process of the present invention, as illustrated in FIG. 1 begins with the preparation of a requisition for purchase (RFP) 16 based on a approved requisition sent to the organizations purchasing department 15. The requisition being the original procurement order submitted to the purchasing department and the RFP the actual item prepared and submitted for bids by service and product providers. As will be noted below often several requisitions may come in from several different departments of the organization and each requisition has portions or items on it that are the same or similar for each department such as standard office supplies. The most efficient way to handle this feature is to combine similar orders. Thus, the creation of RFP's from several different requisitions.

The requisition submitted to purchasing will have gone through an approval process within the organization. Copending U.S. application, owned by the same entity as this application, titled “An Automated Requisition Process and System” Ser. No. ______ filed ______, incorporated by reference herein, describes such a system for the automation of an internal product and service requisition process and system that uses, in a preferred embodiment, the networked computer system of the organization. The system and process described therein could be used in conjunction with that described herein although they both can function as stand alone systems.

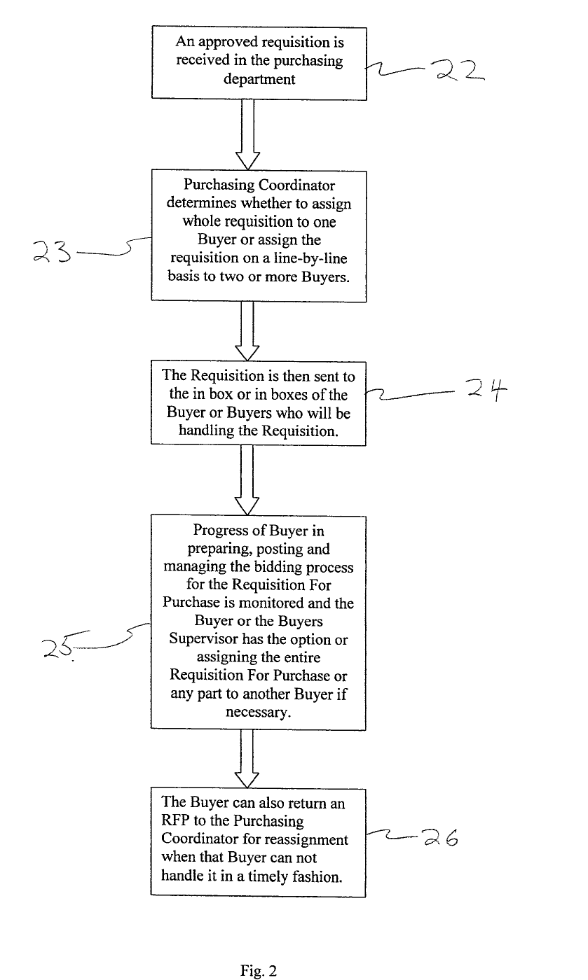

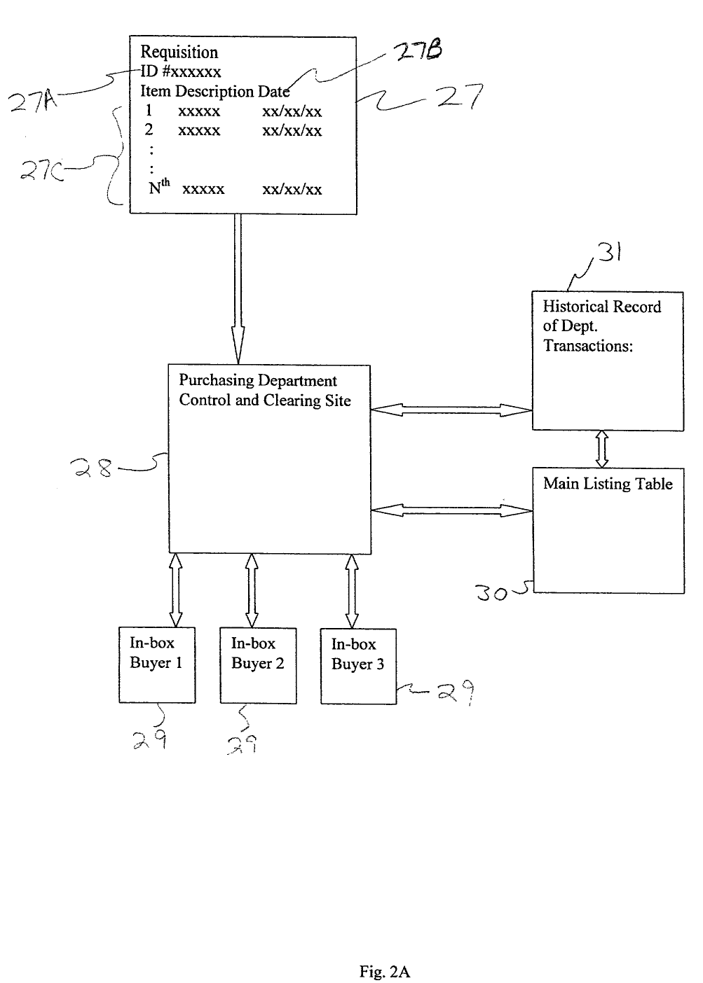

The system of the present invention includes a unique workflow and distribution system for assigning requisitions that arrive in the purchasing department as illustrated by FIG. 2. Once the approved requisition arrives in the purchasing department 22 a Purchasing Coordinator will review it and determine if the requisition should be assigned as a single unit to one Buyer or divided into various segments on a line-by-line basis and assigned to more than one Buyer 23. The line-by-line term referring to the various discrete items, units or parts that make up each requisition arriving at the purchasing department. As noted each requisition may be for a variety of different sundry products. The requisition or a part of it is sent to the in-box 24 of the Buyer assigned to handle that requisition or portion thereof. This feature adds significant flexibility to the system if requisitions with requests for the same or similar items come in from several different departments within the organization. This would allow the Purchasing Coordinator to group together requests for the same or similar items from each of the organizations departments resulting in large coordinated orders for items and the attendant economies of scale thereby created. Thus, if several departments need copier paper one large RFP could be assembled allowing the organization to obtain the copier paper at a lower unit cost as a result of the one large order. Additionally, this would allow for the specialization of Buyers in the handling of RFP's for specific types of products and services and the additional efficiencies this would create.

The system allows for the tracking of the Buyers progress in preparing the RFP from the various requisitions or parts thereof that the Buyer has responsibility for working on and allows for the withdrawal of the requisition from a Buyer's in-box if the Buyer is not able to timely act on the requisition 25. The system would also allow the Buyer to return an requisition or discrete part thereof to the Purchasing Coordinator for reassignment 26.

FIG. 2A illustrates how the workflow is controlled in this manner by the Purchasing Coordinator or his or her subordinates. Each requisition 27 will have its own identification number 27A and action date or dates 27B depending whether each line item 27C has a separate action date. The requisition 27 upon first reaching the purchasing department would go into a control or clearing site 28 from which it can be assigned for action to one or more Buyers by referral of it to the selected Buyer's in-box 29. When a requisition or line item 27C from a requisition is assigned to a Buyer's in-box 29 a record of this assignment is retained in a main listing table 30 in which the current status of a requisition 27 is tracked during the procurement process. If the requisition is transferred to another Buyer's in-box 29 or withdrawn from a Buyer's in-box 29 and not reassigned this information is also retained in the main listing table 30 which keeps track of the current status of each requisition and part thereof. An historical record 31 of all of the movements of the requisition and its various parts is also maintained. The system signals if a critical date 27 is approaching that requires action on a requisition. The signal in the preferred embodiment is automatic notification and change in color of the date as it would appear on a computer screen. The Purchasing Coordinator and his authorized assistants have constant access to all of this information to assist in the smooth handling of the workflow of the department.

The Buyer's in-box feature 29 is unique feature and provides for a flexible, efficient and timely workflow in the purchasing department. The Buyer may include the discrete parts in an RFP for bidding, make a buy based on its inclusion in a posted RFP, assign an award of the item in and RFP to a supplier or reject the item, for what ever reason, and refer it back to the Originator with a mandatory comment as to why it has been rejected and is being returned. The Originator being the individual in the organization that originally requested the item in furtherance of some purpose of the organization.

Naturally, many of the duties of the Purchasing Coordinator could be assigned to assignment staff clerks or similar assistants. Operation of the purchasing department from the top with requisitions being assigned by a Purchasing Coordinator or subordinates is akin to a “push system”. However, the system of the present invention has sufficient flexibility to allow it to be organized as a “pull system” in which the Buyers act as Business Managers and select requisitions to work on as they come in.

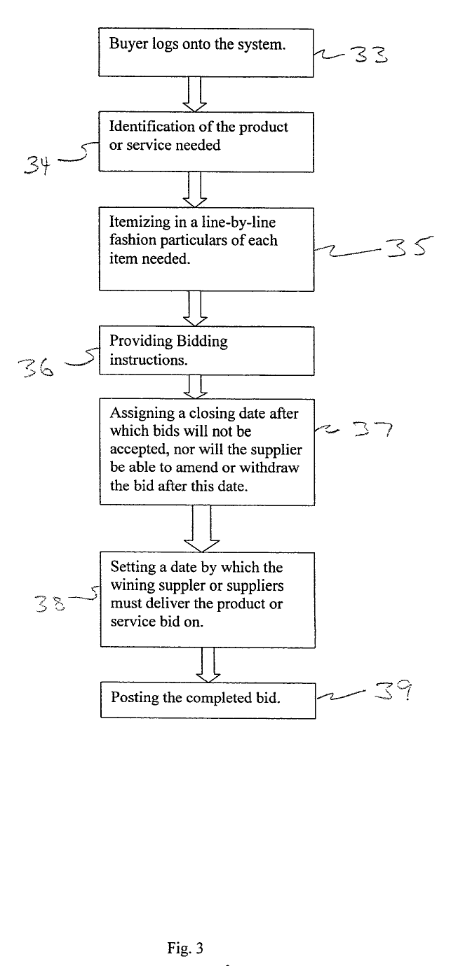

The RFP creation process appears in the flow chart of FIG. 3. The Buyer assigned to creation of the RFP logs onto the system 33. Buyer then proceeds working, with the information contained in the original requisition, through a series of steps to prepare the RFP. Although the actual steps may vary, the following steps would be basic ones for the process: a) identifying 34 the product or service need, b) itemizing in a line by line fashion 35 each specific item, d) providing biding instructions 36, e) assigning a closing date 37 after which bids will not be accepted and f) setting a date by which the items listed in the RFP must be provided by the wining bidder 38. The area of interest in part provides a category that prospective suppliers can search under to determine if open RFP's are pending in the area of products or services that supplier might be interested in bidding on. At this point the Buyer would also determine if the RFP will be awarded to a single supplier or can be split up between one or more suppliers. Finally, the Buyer will post the RFP 39 on the organizations web site for bids.

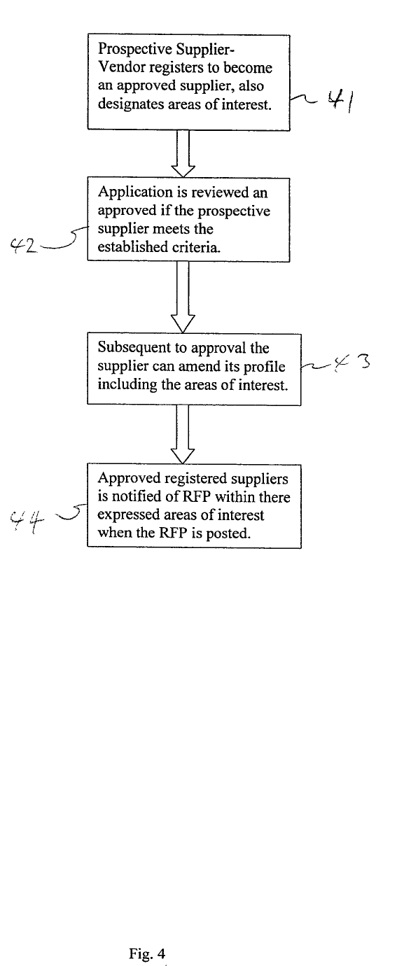

When preparation of the RFP is completed it is posted to the internet site of the organization and e-mails are sent giving notice to registered suppliers that have indicated that the area of interest the RFP relates to is one that they are interested in bidding on. In order for a supplier to register they must have completed a prescribed registration process. FIG. 4 presents a registration process for a preferred embodiment of the present invention. The initial step is the submission by the prospective supplier of an application to become an approved registered supplier 41. The application is then reviewed to determine if the supplier meets the requisite criteria 42. Typically, each organization will have its own self-determined criteria. After the supplier has been approved, the system, if the organization so chooses, can allow the supplier to revise their profile on the system and amend their areas of interest 43. And as noted above, upon the posting of an RFP within the area or areas of interest the supplier has indicated the supplier receives e-mail notification 44.

After becoming aware of the pending RFP in an area of interest, by e-mail or otherwise, the supplier can access the database on the organizations website 46. Upon reviewing the pending RFP, if the supplier has any questions regarding the outstanding RFP the supplier can submit its questions by e-mail 47. The supplier will also be able to view any questions asked by other suppliers and the answers of the organization to those questions 47. The supplier can select an RFP to bid on 48 and submit a bid on the RFP 49. In submitting the bid the supplier will also be supplying specific information about the products or services the supplier has offered to provide 50 as required by the RFP. Such information could relate to specifics about the product or service being offered that may not be readily apparent from the overall bid. The supplier would then submit the completed bid. The invention in its preferred embodiment allows the supplier to modify or withdraw its bid up until the time that bidding closes 52.

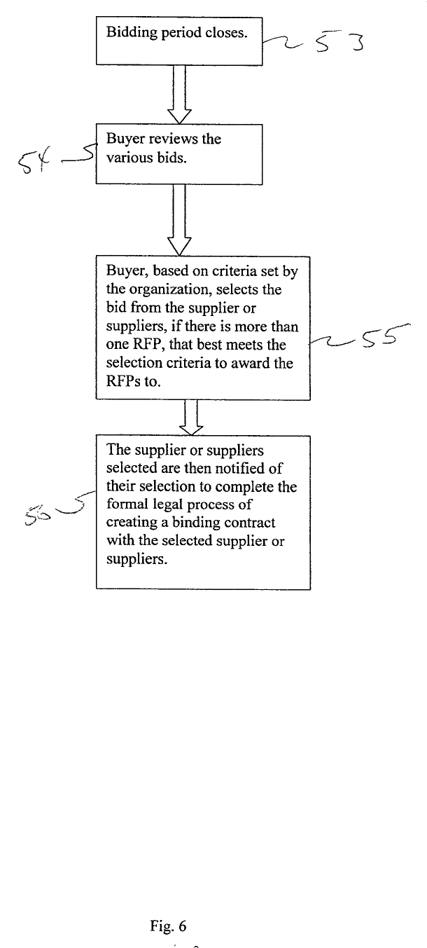

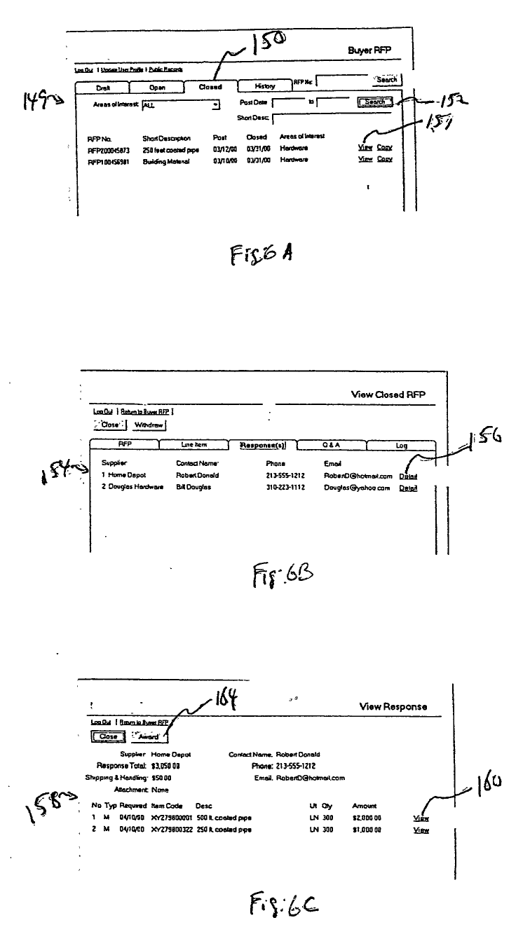

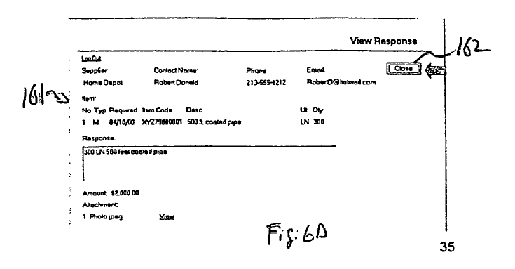

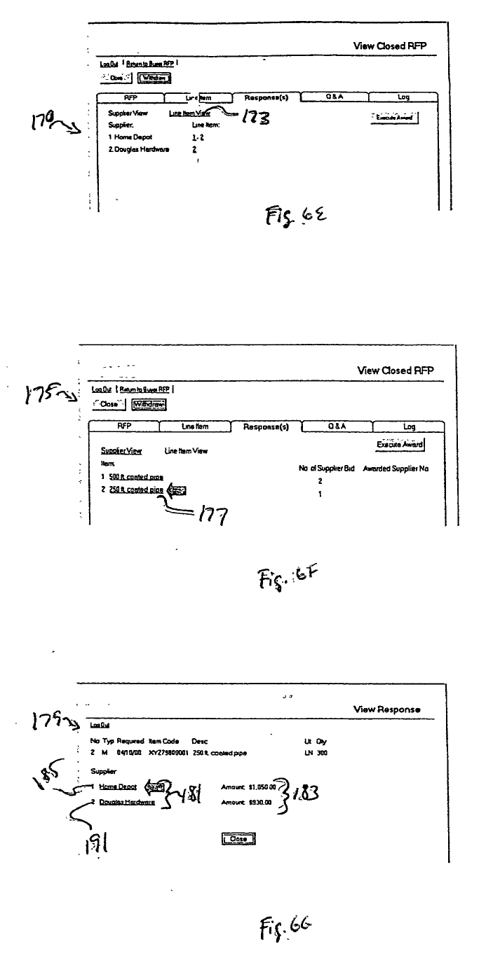

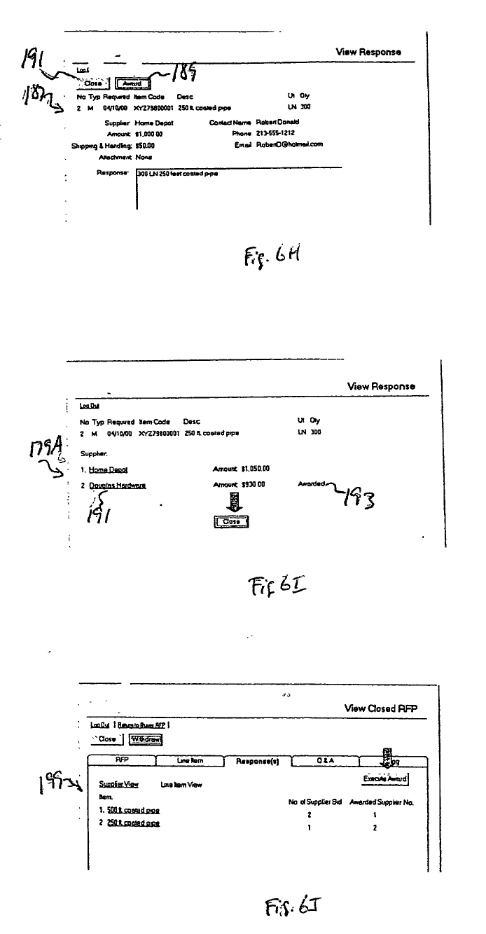

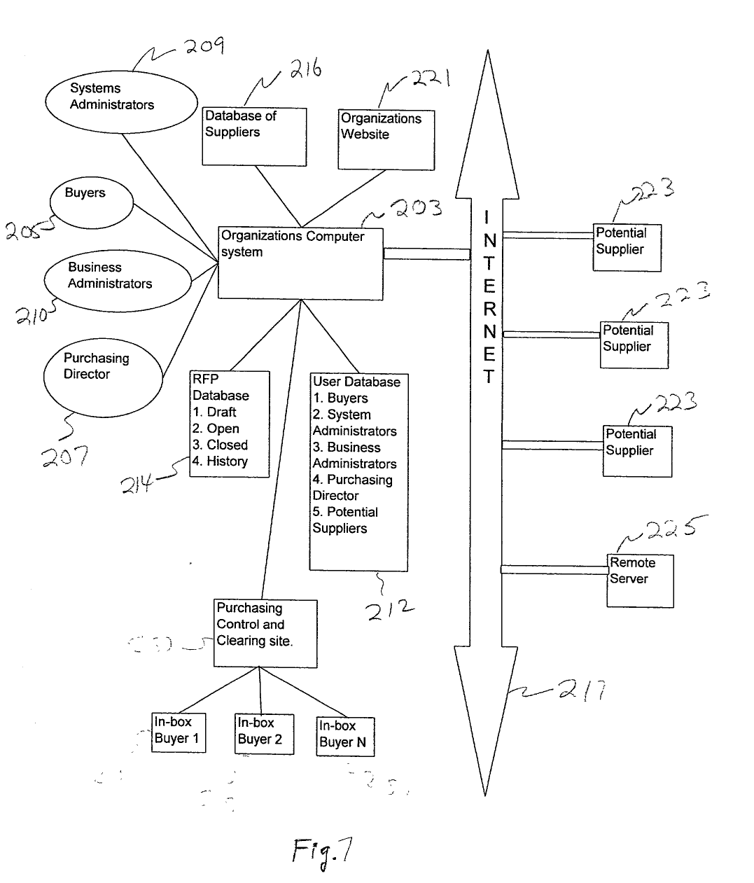

Referring to FIG. 6 once the bidding period closes 53 the responsible Buyer will then review them 54. Based on a proscribed procedure and/or criteria the Buyer will select the winning bid or bids 55. Upon completion of this step the Buyer then sends confirming notice to the suppliers of the acceptance of their bid to complete the formal steps and create a legally binding contract 56.

II. An Example of an Implementation of the System and Process

FIG. 4A depicts the first screen the Buyer might see when he or she first logs on and is FIG. 4B depicts the second screen of the log on process where the Buyer would input his or her user name and password FIG. 4B. In screen 58 in FIG. 4C, the buyer RFP screen, the Buyer would click Draft button 59 (words in italics indicate the action of a person clicking on a button on a computer screen with a pointing device such as a mouse or track ball) and then click Create button 60 and be presented with the screen in FIG. 4D. The Buyer would then enter a short description 61 of the product or service sought, select an area of interest 62 (the product or service category for which the requisition has been submitted) and then add bidding instructions 63. The area of interest in part provides a category that prospective suppliers can search under to determine if open RFP's are pending in the area of products or services that supplier might be interested in bidding on. At this point the Buyer would also determine if the RFP will be awarded to a single supplier or can be split up between one or more suppliers 64.

Next the Buyer would click Line Item tab 65 FIG. 4D and be presented with the screen in FIG. 4E. In the screen 66 the Buyer would add line items 68 the information being: type, date required, item code, description unit and quantity. Also, with each line item the Buyer will be indicating whether or not it is a material item 69 or a service item 70. As the Buyer adds each line he or she can edit it, copy it or delete it 71. The Buyer can also at anytime save 73 the draft, save and close 74 the draft or delete 75 the draft. Additionally, the Buyer can cancel current changes 76 and return to the previous draft. Finally, once the Buyer has completed preparation of the daft he or she can turn it into an open RFP ready for bidding by clicking Post button 77. This last step 77 posts the RFP on the website for bidding. Once posted the RFP enters the “Open” state an e-mail 79 similar to that in FIG. 4F may be sent to registered interested suppliers.

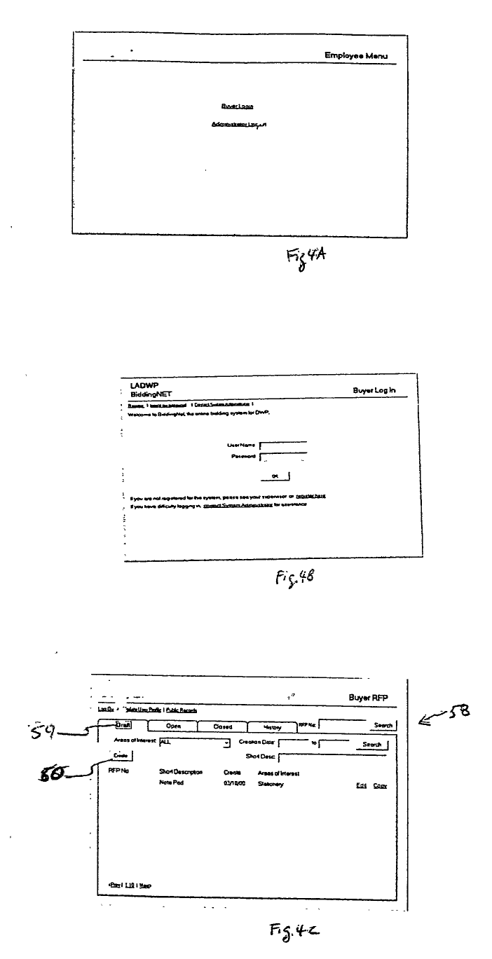

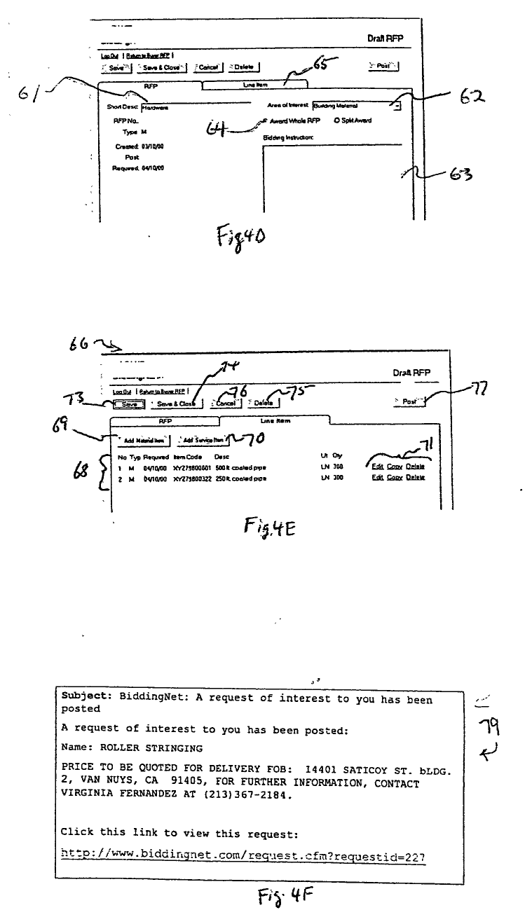

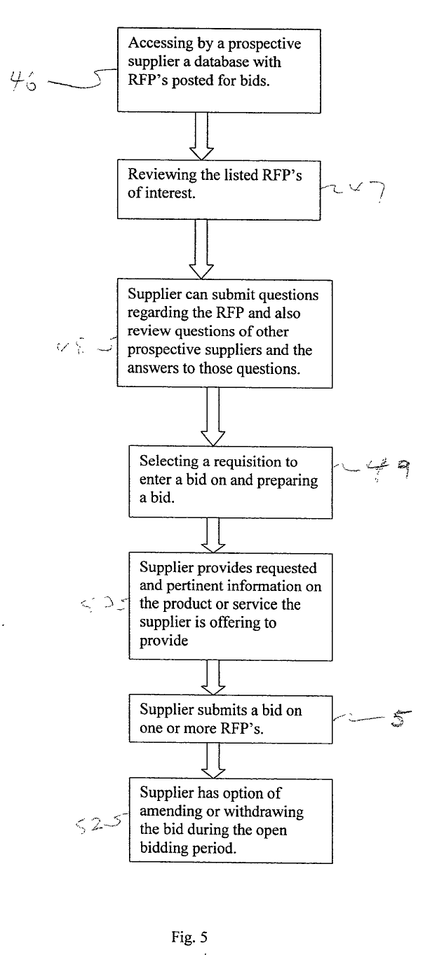

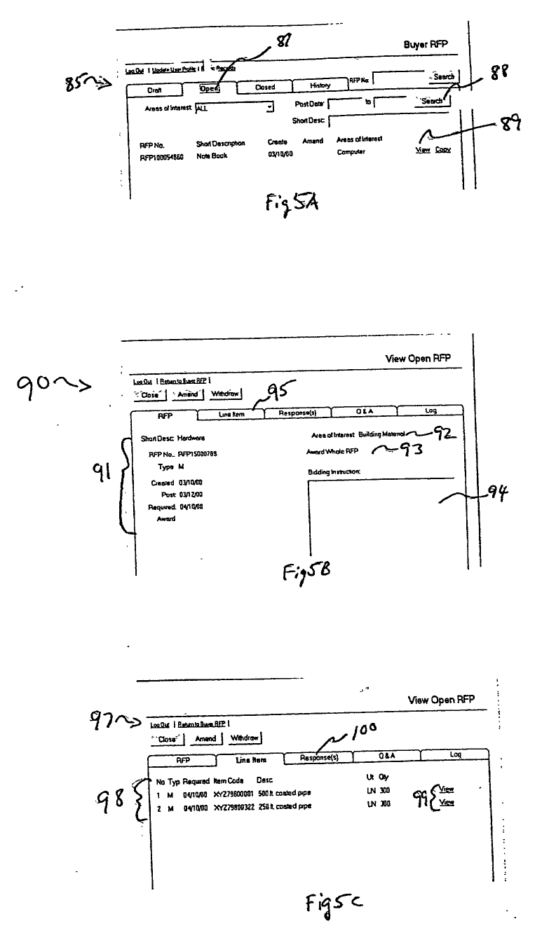

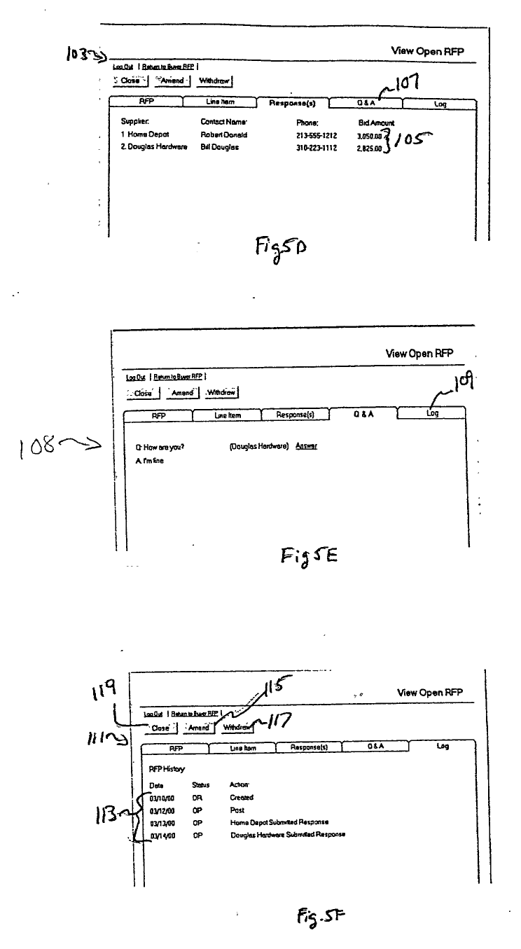

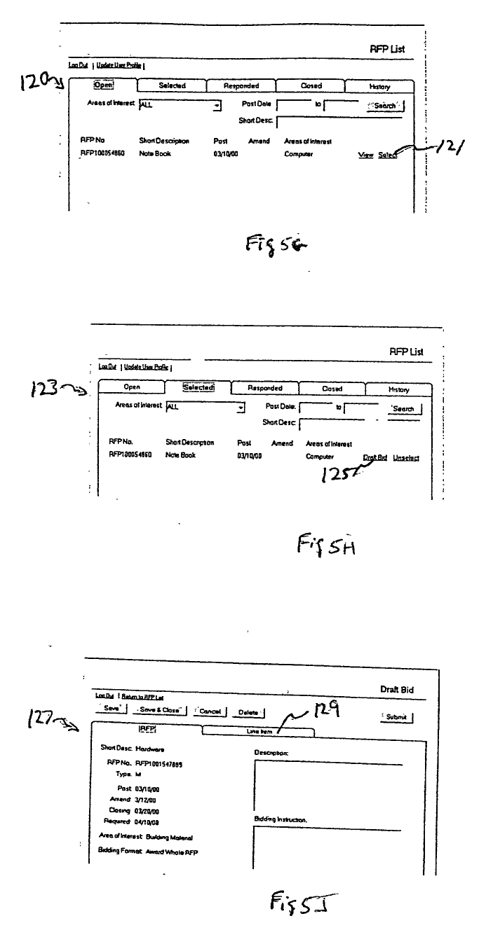

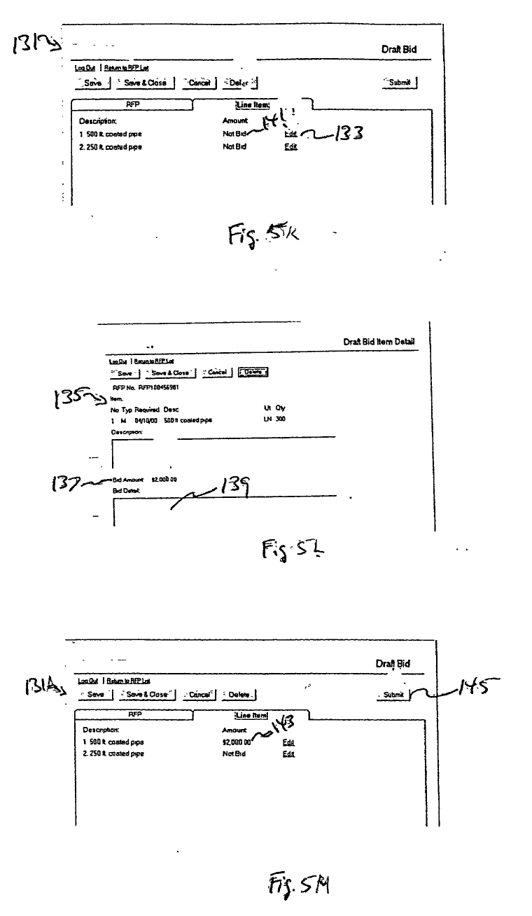

Once the RFP has been posted and e-mails sent to interested suppliers the next step in the process is for prospective suppliers to view RFP at the organization's website. When the supplier accesses the website at which the RFP is posted the supplier in the preferred embodiment might see screen 85 FIG. 5A. The supplier would review open RFP's of interest by clicking Open button 87. If necessary the supplier could use search function 88. To view a listed RFP the supplier would click View button 89 and be presented with screen 90 FIG. 5 B that lists the general information 91 about the open RFP the supplier wishes to view. The area of interest 92 is also listed on this screen together with whether or not the RFP can be awarded as a whole RFP 93 or as a split RFP between two or more suppliers. Additionally, if there were special bidding instructions they would appear at 94. To see a list of the line items the supplier would click Line Item tab 95 and be presented with the screen 97 FIG. 5C.

The line items 98 provide basic information on the products or services needed. To see more detailed information the supplier would click on View button 99 section of each line item. If the supplier would like to see the list of other suppliers that have entered bids to date he or she would click on Responses button 100 and be presented with screen 103 in FIG. 5D. Screen 103 lists the bidding suppliers contact information and amount bid 105. However, the system of the present invention would be adaptable to a sealed bid process and the information on amount of the bid could be withheld. By clicking on Q & A tab 107 the supplier would be presented with screen 108 in FIG. 5E. Here the supplier can peruse questions he or she has left or other suppliers have left and the answers to the questions from the organization. By clicking on Log tab 109 the supplier is presented with screen 111 FIG. 5F. Here the supplier can see a list 113 of events relating to this RFP such as the date the RFP was created and posted. It also provides the dates other suppliers submitted bids. The supplier will also be able to amend 115 his or her own RFP or withdraw the RFP 117. To leave this portion of the website the supplier would click Close tab 119.

After viewing the RFP the supplier has the option of submitting a bid electronically 119. In starting the process of submitting a bid the first screen 120 the supplier might start with is depicted in FIG. 5G at which point the supplier can click Select button 121 to open an RFP selected. Upon making such a selection screen 123 FIG. 5H might appear at which point the supplier would click Draft Bid tab 125. Screen 127 FIG. 5J would appear which has pertinent information. By clicking Line Item tab 129 Screen 131 FIG. 5K appears listing all of the line items relating this RFP and the supplier would click Edit tab 133 of the line item on which the supplier wants to submit a bid. The supplier is then presented with screen 135 FIG. 5L in which the supplier can submit a bid amount 137 and details 139 relating to his or her bid. The supplier would then return to the Draft Bid screen 131A on which the “not bid” legend (see 141 FIG. 5K) has changed to $2,000 at 143 FIG. 5M. Upon completing bids on all line items in this fashion the supplier can then submit the bids by clicking Submit button 145.

Once the bidding on an RFP closes on the preset date the next step typically is the awarding the RFP to a supplier. Each organization will have its own criteria for the selection process and it will be based on that selection process as applied to the relevant particulars of each bid. The system of the present invention is completely adaptable to any relevant selection criteria. In the selection process the Buyer will start with screen 149 in FIG. 6A that lists the closed RFP's. The Buyer would have selected the screen by clicking Closed button 150. If the closed RFP appears on screen 149 the Buyer will select it for viewing by selecting View button 151. Alternatively, the Buyer has the option of conducting a search by using Search function 152. Once the Buyer is viewing the closed RFP the Buyer can then review the bids submitted as illustrated on screen 154 in FIG. 6B. The Buyer can then review the details of each bid by selecting Detail button 156 for the bid that is to be reviewed. Screen 158 in FIG. 6C illustrates what the particulars are with respect to the bid of one of the supplies that bid on the RFP. The Buyer will then press View button 160 to see the particulars of each line item. Screen 161 in FIG. 6D illustrates an example of what the Buyer will typically will see. After reviewing it the Buyer will click Close button 162 to return to the main screen 158 of the supplier-bidder in FIG. 6C. Assuming the Buyer has determined to award the RFP to the indicted supplier on screen 158 the Buyer would click Award button 164. As part of the award process the Supplier being awarded the RFP could automatically receive an e-mail confirming it.

The process in the situation where the RFP consists of a split award among two or more suppliers differs somewhat from a single award RFP. Initially, the Buyer would view the Closed RFP screen that lists responses 170 in FIG. 6E. The Buyer would click Line Item View button 173 and be presented with a screen 175 FIG. 6F, listing line items in the RFP. The Buyer would then select a line item 177 for review and then be presented with a screen 179, View Response screen, FIG. 6G listing the bidders 181 and the amount 183 of each suppliers bid. At this point the Buyer might first review the particulars of each bid first by clicking on the first supplier whereupon the Buyer would be presented with a screen 187 in FIG. 6H. After reviewing it the Buyer could either award the partial RFP for this line item to this supplier by clicking Award key 189 or not award it by clicking the Close key 191 which would return the Buyer to screen 179 in FIG. 6G. At this point the Buyer can click on the next supplier 191 and the Buyer would be presented with a screen, not shown, similar to 187 in FIG. 6H that would present details of the bid of the second supplier 191 in FIG. 6G. If the Buyer decided to award the second supplier 191 this line item of the RFP the Buyer would click the Award button on that screen and be returned to View Response screen 179A FIG. 61. This screen is the same as screen 179 in FIG. 6G with the exception that the particular line item shown on screen 179A in FIG. 6I has the indication that it has been awarded 193 to the second supplier 191. Thus, the Buyer would proceed through each line item examining and comparing each bid on each line item and individually award the line item to any of the suppliers bidding. Upon completion of the awarding of each line item the Buyer can review a summary of the awards on screen FIG. 6J.

III. The Major Functional Parts of the System

FIG. 9 is a block diagram of the fundamental functional parts of the system of the present invention and the environment in which it works. At the center is the organizations networked computer system 203. Employees have, as noted above, access to the network and use it with a personal computer connected to the network. Each employee also has his or her own unique electronic address, typically an e-mail address, from which they can communicate with other individuals in the organization through the computer system. The process of the present invention in its preferred embodiment classifies each employee in one or more of the following classifications: 1) Buyers 205, those individuals responsible for preparing draft RFP's, posting them and awarding RFP's to successful bidder-suppliers. Buyers can also amend or withdraw open RFP's. Buyers can also respond to supplier's questions. 2) Purchasing Director or Coordinator 207 manages the activities of the Buyers. A Purchasing Director can view all RFP's regardless of its status. They also can, with respect to Buyers, approve their authority as Buyers and remove that approval or reassign them. Purchasing Directors can approve the registration of suppliers and also deactivate the registration of suppliers etc. 3) Systems Administrators 209 manage the technical aspects of the operation of the system and have authority to alter system variables. 4) Business Administrator 210 is a senior management position having over all responsibility for both Purchasing Directors 207 and Buyers 205 and the general management of the purchasing department. Business Administrators also have the authority to activate and deactivate the registration of suppliers.

All of the information concerning each of the functional positions of Buyers, Purchasing Directors etc. is saved in a User Database 212. This database would not only include contact information of each of these individuals including e-mail address it would also include user ID's and access codes etc. The system also has an RFP database 214 in which all of the relevant information concerning the RFP's are saved including the stage of development, i.e. Draft, Open, Closed or History. Additionally, all information and transactions concerning each RFP is saved in a locked format that is archived. This preserves a clear record for audits that may be necessary in the future.

The system also has a database of suppliers 216 that has contact information, including an e-mail address, and other information regarding the supplier deemed necessary. This could include financial and credit information as well as the area of interest of the supplier with respect to the type of products or services they supply. The information on the area of interest will allow the system to send the supplier an automatic e-mail of any posted RFP's are for products or services they supply, i.e. their area of interest.

Naturally, the system is connected to the internet 217 so that the website 221 of the organization is accessible form the internet by prospective suppliers. Prospective or potential suppliers 223 would have to have their own connection to the internet to be able to use the system of the present invention. Naturally, the system, in a preferred embodiment described above would include the purchasing control and clearing site 250 and the Buyer's in-boxes 251. It would also include the main listing table and historical record, which in a preferred embodiment, would form part of the RFP database although they could be implemented as separate and distinct databases.

The preceding description has described the present invention in broad modeling terms. Naturally, part of the system will include a computer software program or programs running on the organizations computer system 203 or on a remote server 225 provided by an outside service provider. The preceding disclosure does not include any indication of the computer operating code or the relevant source code necessary for functioning software. This is due to the fact that those of ordinary skilled in the art once they have reviewed and understand the particulars of the present invention will be able to compose the necessary software without undue experimentation. In fact those of ordinary skill in the art once having read and understood the particulars of the present invention will appreciate that the software necessary can be written in a variety of different languages and in a variety of different formats. The foregoing description has also included a set of computer screens to help illustrate the process and system of the present invention. However, those skilled in the art will realize, after reviewing the preceding specification that the invention described herein can function with a variety of different computer display screens that can differ significantly from those used for illustrative purposes herein.

While the invention has been particularly shown and described with reference to a preferred embodiment thereof, it will be understood by those skilled in the art that various changes in form and detail may be made to it without departing from the spirit and scope of the invention.

We claim:

1. A method for an organization to conduct a bidding process for products or services it needs comprising the steps of:
a) creating a requisition for purchase of sundry items or services needed;
b) requiring any potential supplier that wants to bid to register, wherein registering includes:
1) providing contact information and other information deemed relevant by the organization;
2) verifying by the organization said potential supplier meets certain predefined criteria;
3. having the potential supplier indicate at least one area of interest to supply service or products, said area of interest being a category of supplies or services the organization may need; and
4) approving said potential supplier as an authorized supplier with authority to submit bids when said potential supplier meets said predefined criteria.
c) notifying registered potential suppliers when the requisition is for services or products in the category of the at least on area of interest the potential supplier selected.;
d) providing prospective suppliers with a detailed copy of the requisition on which they can determine if they want to make a bid;
e) accepting from prospective suppliers bids for supplying the product or service sought by the requisition;
f) closing the bidding process at a preset date; and
g) awarding the requisition to one of the prospective suppliers that submitted a bid.

2. The method of claim 1 wherein the step of accepting bids further comprises accepting sealed bids from potential suppliers and the step of awarding said bids comprises the step of first unsealing the bids, reviewing the bids and then granting the bid to a potential supplier based on a pre-selected criteria.

3. The method of claim 1 wherein the step of creating a requisition includes the step of determining if the whole requisition should be awarded as a single unit to one supplier or if it can be broken up into several units and with each unit being awarded to one or more suppliers.

4. The method of claim 1 wherein the step of creating the requisition for purchase comprises the steps of:
a) identifying the product or service needed;
b) itemizing in a line by line fashion particulars of each item being sought by the requisition;
c) providing bidding instructions;
d) assigning a closing date after which bids will not be accepted; and
e) setting a date by which the items being bid on must be supplied by a supplier awarded the requisition.

5. The method of claim 1 wherein the step of accepting electronic bids from prospective suppliers includes:
a) selecting by the prospective supplier a requisition to enter a bid on;
b) making by the prospective supplier an offer to supply a service or product listed in the requisition at a specific price; and
c) providing by the prospective buyer particular information regarding the service or product the prospective supplier proposes to provide to fulfill an award of the bid.

6. The method of claim 1 wherein the step of awarding the requisition includes the following steps:
a) changing the requisition to a closed status;
b) reviewing the bids made by various prospective suppliers; and
c) selecting from the bids offered one to which the requisition will be granted based on the organizations selection criteria.

7. The method of claim 1 wherein the step of creating a requisition includes the steps of:
a) time period during which said prospective suppliers who have bid to alter or withdraw their bid;
b) setting a specific time when bids can no longer be withdrawn or altered; and
d) setting a final date and time by which bids must be submitted.

8. The method of claim 1 including the further step of saving in a locked format. a) all posted requisitions, 2) all modifications or changes made to said requisitions, 3) all bids made and 4) the bid to which the requisition was awarded.

9. The method of claim 8 including the further step of archiving the information saved in a locked format for future audit purposes.

10. The method of claim 1 wherein the potential supplier has the option of submitting questions to the organization regarding the requisition; and issuing of answers by the organization.

11. The method of claim 10 including the further step making public the question and answer by the organization.

12. A method for an organization to conduct a bidding process for products or services it needs on a computer system over the internet comprising the steps of:
a) creating a requisition for purchase of sundry items or services needed;
b) posting the requisition for purchase on an electronic site accessible over an internet wherein the requisition is accessible by third parties over the internet;
c) notifying by electronic mail prospective suppliers of the services or products requested in the requisition, of the existence of the pending requisition;
d) allowing prospective suppliers to access view the requisition on line;
e) accepting from prospective suppliers electronic bids for supplying the product or service sought by the requisition;
f) closing the bidding process at a preset date; and
g) awarding the requisition to one of the prospective suppliers that submitted a bid.

13. The method of claim 12 including the further steps of:
a) requiring any potential supplier that wants to bid to register;
b) registrating by the potential seller includes providing contact information and other information deemed relevant by the organization;
c) verifying by the organization said potential supplier meets certain predefined criteria; and
d) approving said potential supplier as an authorized supplier with authority to submit bids when said potential suppliers meets said predefined criteria.

14. The method of claim 12 including the further step of allowing the potential supplier to ask questions regarding the requisition during the bid period and answering the questions by the organization.

15. The method of claim 14 including the additional step of making the questions and answers on the site accessible over an internet.

16. The method of claim 12 wherein the step of accepting bids further comprises accepting electronically sealed bids from potential suppliers and the step of opening said bids for review comprises the step of first unsealing the bids before opening said bids for review so that a sealed bid process is maintained.

17. The method of claim 13 wherein the step of notifying prospective suppliers of the existence of the requisition comprises notifying only authorized supplier.

18. The method of claim 12 wherein the step of creating a requisition includes the step of determining if the whole requisition should be awarded as a single unit to one supplier or if it can be broken up into several units and with each unit being awarded to one or more suppliers.

19. The method of claim 12 wherein the step of creating the requisition for purchase comprises the steps of:
f) identifying the product or service needed;
g) itemizing in a line by line fashion particulars of each item being sought by the requisition;
h) providing bidding instructions;
i) assigning a closing date after which bids will not be accepted; and
j) setting a date by which the items being bid on must be supplied by a supplier awarded the requisition.

20. The method of claim 12 wherein the step of accepting electronic bids from prospective suppliers includes:
a) allowing accesses by a prospective supplier to a database with requisitions posted at the accessible site;
b) selecting by the prospective supplier a requisition to enter a bid on;
c) making by the prospective supplier an offer to supply a service or product listed in the requisition at a specific price; and
d) providing by the prospective supplier particular information regarding the service or product the prospective supplier proposes to provide to fulfill an award of the bid.

21. The method of claim 12 wherein the step of awarding the requisition includes the following steps:
e) changing the requisition to a closed status;
f) reviewing the bids made by various prospective suppliers; and
g) selecting from the bids offered one to which the requisition will be granted based on the organizations selection criteria.

22. The method of claim 12 wherein the step of creating a requisition includes the steps of:
a) time period during which said prospective suppliers who have bid to alter or withdraw their bid;
b) setting a specific time when bids can no longer be withdrawn or altered; and
h) setting a final date and time by which bids must be submitted.

23. The method of claim 12 including the further step of saving in a locked format: a) all posted requisitions, 2) all modifications or changes made to said requisitions, 3) all bids made and 4) the bid to which the requisition was awarded.

24. The method of claim 23 including the further step of archiving the information saved in a locked format for future audit purposes.

25. A system for soliciting bids from potential suppliers for product or service needs of an organization over the internet comprising:
a) a computer of an organization connected to the internet;
b) an interactive memory site on said computer accessible from the internet by third parties connected to the internet;
c) requisitions for purchases sought by the organization stored at said interactive site and for viewing by those who obtain access to the site from the internet;
and
d) bid protocol available to third party suppliers to view requisitions at said interactive memory site and leave an offer to supply a product or service itemized in the requisition, when said third party supplier obtains access to said interactive memory location from a connection to the internet.

26. The system of claim 25 wherein said bid protocol also provides for the classification of individuals within the organization using the system as buyers who prepare the requisitions for the bid process, business administrators with authority to appoint buyers and authorize suppliers to register so they can bid on requisitions, systems managers to manage technical aspects of the entire system and purchasing directors who have access to all requisitions and authority to appoint buyers and authorize suppliers to register so they can bid on requisitions.

26. The system of claim 25 in which the system saves all requisitions and related information in a locked format.

27. The system of claim 25 in which the requisitions are saved in a requisition database classified as a draft requisition for those in preparation, as open requisition for those that have been posted and the bid period still has not expired, a closed requisition for those for which the bid period has expired and historical requisition for those that have been fulfilled.

28. The system of claim 25 wherein the interactive site is a website of the organization.

29. A method for providing a smooth work flow in an organization for product or service procurement comprising the steps of:
a) uniquely identifying a requisition for a product or service on submission of the requisition for action;
b) assigning various discrete portions of the requisition to various individuals responsible for an organizations procurement on a preset basis;
c) retraining a current record of the status and location of each uniquely identified requisition and its various discrete parts;
d) creating an historical record of all transactions involving each requisition and their various discrete parts;
e) retaining a permanent, readable and unalterable record of the historical record of all transactions involving each requisition and its discrete parts;
f) flagging each discrete part of each requisition with a required action date; and
g) generating a warning signal when the required action date will arrive in a preset time.
